(19) United States
(12) Patent Application Publication
(10) Pub. No.: US 2011/0186493 A1
(43) Pub. Date: Aug. 4, 2011

(54) ORGANIC ECO-AGRICULTURAL WATER SYSTEM

(76) Inventor: WEN-LO CHEN, Taipei City (TW)

(21) Appl. No.: 12/698,152

(22) Filed: Feb. 2, 2010

(51) Int. Cl. C02F 1/78

(52) U.S. Cl. 210/192

(57) ABSTRACT

An organic eco-agricultural water system includes a water source, a water discharge device connected to the water source by a pipeline, and ozone generators installed in the pipeline between the water source and the water discharge device and controlled to generate ozone and to supply generated ozone to the water flowing through the pipeline proportionally subject to the flow rate of the water passing through the pipeline. The discharged water can be used for application on crops or for the purpose of irrigation to save consumption of agricultural chemicals.

### BACKGROUND OF THE INVENTION

1. Field of the Invention

The present invention relates to aquaculture technology and more particularly, to an organic eco-agricultural water system for supplying sterilized water for agricultural application.

2. Description of the Related Art

To assure a high harvest volume, agricultural chemicals are popularly applied. In developed countries, there are regulations to limit the time and amount of the use of pesticides or agricultural chemicals, avoiding excessive amount of residual agricultural chemicals in crops. However, human control cannot make people feel insecure. Toxics experts suggest people to keep vegetables and fruits few days before cooking or eating, enabling the residual pesticides to be completely decomposed subject to the effect of the enzyme in the vegetables or fruits.

People in the modern society who care about healthy life are willing to pay more to by organic vegetables and fruits.

“Organic farming is the form of agriculture that relies on crop rotation, green manure, compost, biological pest control, and mechanical cultivation to maintain soil productivity and control pests, excluding or strictly limiting the use of synthetic fertilizers and synthetic pesticides, plant growth regulators, livestock feed additives, and genetically modified organisms”. However, organic farming requires much labor and farming time, resulting in a high cost. Not every people can afford to buy organic agricultural vegetables and fruits.

A responsible government must do care about the health of every citizen. It is well known that a close mouth catches no flies. It is the most economic way to care about people's health by protecting people from eating harmful foods. Keeping people healthy can save medicare expenses. It is easy to maintain the health of every citizen easily if the government or farmers would provide cheap and safe vegetables and fruits that avoid people from eating residual pesticides and that are cultivated by means of a low-cost non-toxic cultivation method.

### SUMMARY OF THE INVENTION

The present invention has been accomplished under the circumstances in view. It is one object of the present invention to provide an organic eco-agricultural water system, which is practical for agricultural application to apply ozonated water to crops, keeping vermin away from the crops and preventing agricultural pests and diseases.

To achieve this and other objects, ozone is generated and mixed with the water that is delivered from a water source to the water discharge device, thereby sterilizing the supplied water. The ozonated water is not harmful to human body. When the ozonated water is applied to crops, it kills vermin or keeps vermin away from the crops, thereby preventing agricultural pests and diseases.

It is well known that the ozone layer is a layer mainly located in the lower portion of the stratosphere from approximately 20˜30 km above Earth which contains relatively high concentrations of ozone (O3) about 0.02˜0.04 ppm. This layer absorbs 93-99% of the sun's high frequency ultraviolet light, which is potentially damaging to life on earth.

Ozone degradation speed varies with the amount of heat, light and water content and the range of pH value. Oxides and other catalysts accelerate ozone degradation. Ozone water can kill bacterial and virus. Ozone decomposes in water in OH-radicals. Dependent on the nature of the dissolved matter, these can accelerate or slow down the decay of ozone. Ozone is a powerful oxidizing agent, far better than dioxygen. It is also unstable at high concentrations, decaying to ordinary diatomic oxygen: 2 O3→3 O2. This reaction proceeds more rapidly with increasing temperature and decreasing pressure. Deflagration of ozone can be triggered by a spark, and can occur in ozone concentrations of 10 wt % or higher.

Ozone has many characteristics as follows:

(1) The half life of ozone in the atmosphere (room temperature) is 30 seconds, and it changes subject to variation of temperature.

(2) The half life of ozone is 20 seconds in water. Ozone degradation in water will be accelerated when the pH value in the water becomes high, or slowed down when the pH value in the water becomes low.

(3) When ozone is dissolved in water, it breaks down rapidly to kill bacteria, to remove bad smell and to produce a bleaching effect.

(4) Ozone atoms can be adhered to an object to cause a reaction before and after degradation in the water.

(5) When ozone is degraded, [HO—] is produced.

(6) The oxidizing power of [HO—] is −2.8V, higher than ozone.

(7) The oxidizing power of ozone is −2.7V in an acidic solution, or −1.2V in an alkaline solution.

(8) When ozone and harmful substances decayed to ordinary diatomic oxygen, no any secondary pollution will occur.

Ozone can oxidize many organic compounds. Because ozone is a powerful germicide, it can be used to sterilize air and water. Insects and vermin are driven away from high levels of ozone. Ozone not only helps remove their odors it keeps them from coming back. Because gaseous ozone is highly reactive, it readily oxidizes (breaks down) organic matter. When the ozone encounters another compound, one oxygen atom will break away, attach itself to the compound, and oxidize it. Ozone actually breaks down odor causing compounds, thereby eliminating the odor and changing the ozone back to oxygen (O2).

Ozone used in industry is measured in g/nm3 or weight percent. It can be produced in many different ways, such as ultraviolet light method, corona discharge method and cold plasma method. Ozone may be formed from O2 by electrical discharges and by action of high energy electromagnetic radiation. Ozone can also be produced by electrolysis. Any of a variety of conventional commercial ozone generators may be used in the present invention. Due to the strongly oxidizing properties of ozone, ozone is a primary irritant, affecting especially the eyes and respiratory systems and can be hazardous at even low concentrations. The permissible exposure limit of ozone concentration is 0.1 ppm. Ozone can be used to remove manganese from water, forming a precipitate which can be filtered. Ozone will also turn cyanides to the one thousand times less toxic cyanates. Finally, ozone will also completely decompose urea.

In one example of the present invention, the aquaculture sterilization system includes a water source, at least one water discharge device connected to the water source by a pipeline and at leas tone ozone generator installed in the pipeline between the water source and the at least one water discharge device and controlled to generate ozone and to supply generated ozone to the water flowing through the pipeline proportionally subject to the flow rate of the water passing through the pipeline. The ozonated water that is discharged out of the at least one water discharge device can be used for application on crops or for the purpose of irrigation to save consumption of agricultural chemicals.

Further, the water source can be a water tower or in-ground water reservoir. Further, the water discharge device can be a water sprayer or nebulizer.

### BRIEF DESCRIPTION OF THE DRAWINGS

FIG. 1 is a system block diagram of an organic eco-agricultural water system in accordance with a first embodiment of the present invention.

FIG. 2 is a system block diagram of an organic eco-agricultural water system in accordance with a second embodiment of the present invention.

### DETAILED DESCRIPTION OF THE PREFERRED EMBODIMENT

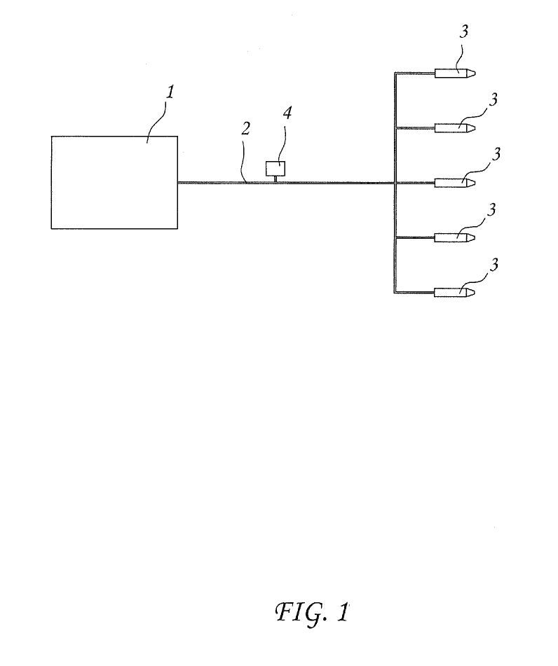

Referring to FIG. 1, an organic eco-agricultural water system in accordance with a first embodiment of the present invention is shown comprising a water source 1, at least one water discharge device 3, a pipeline 2 and at least one ozone generator 4 installed in the pipeline 2.

The water source 1 can be a water tower at a high place, or an in-ground water reservoir. The pipeline 2 can be embedded under the ground, or arranged above the ground. Further, the at least one ozone generator 4 is installed in the pipeline 2 at a selected location or selected locations. Each ozone generator 4 has the ozone output port thereof disposed in communication with the water passage in the pipeline 2 so that generated ozone can be mixed with the water that flows from the water source 1 through the pipeline 2 toward the aquacultural pond 3, thereby forming an ozonated water. When the ozonated water is applied to crops through the at least one water discharge device 3, it keeps vermin away from the crops. To assure a high level of application safety, the output amount per unit time of the at least one ozone generator is adjustably controlled subject to the flow rate of the pipeline 2 so that the ozone concentration in the ozonated water to be discharged out of the at least one water discharge device 3 is properly controlled.

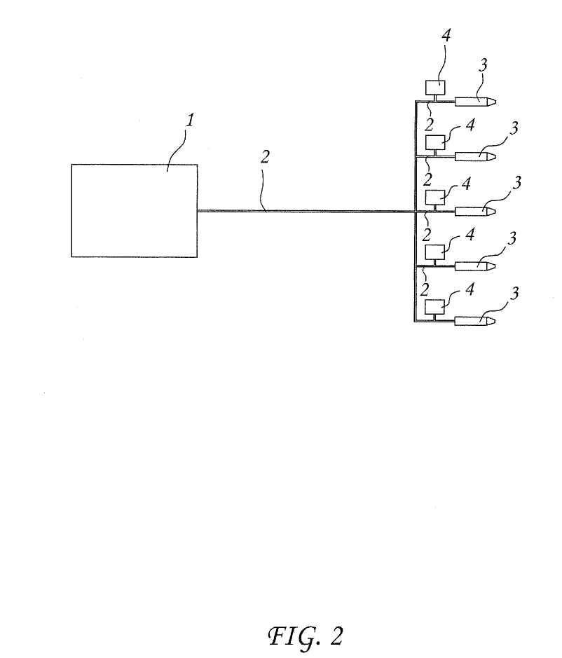

FIG. 2 illustrates an organic eco-agricultural water system in accordance with a second embodiment of the present invention. According to this second embodiment, the organic eco-agricultural water system comprises a water source 1, a pipeline 2 extended from the water source 1 and terminating in multiple branch lines 21, a plurality of water discharge devices 3 respectively connected to the ends of the branch lines 21, and a plurality of ozone generators 4 respectively installed in the branch lines 21 of the pipeline 2. This second embodiment allows the user to selectively close or open the ozone generators 4 and the water discharge devices 3.

Although particular embodiments of the invention have been described in detail for purposes of illustration, various modifications and enhancements may be made without departing from the spirit and scope of the invention. Accordingly, the invention is not to be limited except as by the appended claims

What the invention claimed is:

1. An organic eco-agricultural water system, comprising:
a water source;
water discharge means connected to said water source by a pipeline; and
ozone generator means installed in said pipeline between said water source and said water discharge means and controlled to generate ozone and to supply generated ozone to the water flowing through said pipeline proportionally subject to the flow rate of the water passing through said pipeline.

2. The organic eco-agricultural water system as claimed in claim 1, wherein said water source is a water tower.

3. The organic eco-agricultural water system as claimed in claim 1, wherein said water source is an in-ground water reservoir.

4. The organic eco-agricultural water system as claimed in claim 1, wherein said water discharge means is a water sprayer.

5. The organic eco-agricultural water system as claimed in claim 1, wherein said water discharge means is a nebulizer.
